(19) United States
(12) Patent Application Publication
(10) Pub. No.: US 2009/0094741 A1
(43) Pub. Date: Apr. 16, 2009

(54) Sink and lavatory shell

(76) Inventors: Armando Valadez, Yorba Linda, CA (US); Violeta Valadez, Yorba Linda, CA (US)

Correspondence Address: ARMANDO VALADEZ AND VIOLETA VALADEZ, 25685 CROSS CREEK DR. #38C, YORBA LINDA, CA, 92887, US

(21) Appl. No.: 11/973,795

(22) Filed: Oct. 11, 2007

(51) Int. Cl. A47J 47/20; E03C 1/186

(52) U.S. Cl. 4/658

(57) ABSTRACT

This new product provides an intuitive approach on how to improve the care, maintenance and look of your kitchen and bathroom. A few of the improvements this product provides are: It reduces the amount of time and frequency of cleaning the kitchen or bathroom by limiting the amount of area exposed to dirty water, soap, toothpaste, etc. For example when you brush your teeth the toothpaste and water splashes on the walls, mirrors, faucet and counter. This product eliminates the splashing of fluids by confining the area that is exposed. This product eases cooking by providing additional electrical outlets for additional appliances, therefore eliminating the need to unplug appliances already plugged utilizing the outlets in the kitchen. It also provides additional lighting which makes washing vegetables, dishes. The lighting also eliminates the need to use the overhead lights in the kitchen and provide a direct source of light to the work area. For example, at night or early in the morning, when using the bathroom to shave, brush your teeth, wash your face or hands, you could utilize the lighting within the shell to give you a direct source of lighting where it is needed instead of turning on the overhead lights. This product also greatly increases the life expectancy and look of your faucets and knobs by eliminating the exposure of the faucets and knobs to water, toothpaste, shaving cream, etc. Water and the products we use everyday cause the deterioration of the faucets and knobs by causing them to rust. Water also creates mildew buildups, hard water deposits, calcium and lime buildups, which cost time and money to replace if they are not cleaned and treated on a timely basis.

### BACKGROUND OF INVENTION

This new product can be attached to any sink or lavatory in the home or industrial setting. The purpose of this new design is to keep areas around the sink and lavatory (behind the faucet, mirrors and the counter around it) clean, stain free and dry. Before this invention, I found myself frustrated at the fact that after washing dishes, fruits, vegetables or anything else that was near the sink became surrounded by dirty water (full of bacteria) and soap all around the outside of the sink, on the countertop and in between the knobs, contaminating everything it touches. Another issue I had in the kitchen was the desire to have the ability to use additional items, such as a television or radio, for either entertainment purposes or to utilize the television for special recipes. With these desires in mind it created another problem: Where to plug in these new utilities safely and without having to unplug other appliances already utilizing the outlets? During a time when energy is scarce, I realized that when I was washing dishes in the kitchen or brushing my teeth at night, I did not have the need to turn on the overhead lights to see.

The bathroom sink is often used at least one time each day by each person in the household. After each use, the mirrors, immediate area surrounding the sink, the knobs and faucet become covered with soap, toothpaste and water. This created a mess every time someone used the sink and in turn created a source of irritation due to the amount of constant cleaning this area required. The biggest problem I found was the rust, calcium and mildew buildup created by the prolonged exposure to the immediate areas around the sink.

This is a constant and costly problem in every household. This problem also occurs on a much larger scale in the commercial industry. Hotels have hundreds, sometimes thousands of bathrooms which require constant maintenance. Restaurants are required to keep the kitchen area clean and sanitized which can be difficult during peak hours. Another problem I encountered was the desire to make the sink and lavatory areas in my home more appealing.

### DETAILED DESCRIPTION

This new product can be manufactured in the same standard sizes used to make sinks and lavatories in the home and industrial settings (single, double, triple, circular, oval, irregular, even cater-cornered sinks) (see FIGS. 1, 2, 3, 4, 5, 6, 7 & 8) using the following materials: solid wood, particle board, stainless steel, aluminum alloy, brass, titanium, ceramic even tempered glass; or synthetic materials such as fiber glass, acrylics, plastics, carbon fiber, etc. If metal materials are used for manufacturing, they can be plated for protection or to make any desired texture. Metal shells can be manufactured using the same processes as cutting sheet metal (A preprogrammed or predesigned matrix (acetylene and oxygen, water jet, laser, etc). Other alternative processes are forming and welding metal materials and molding. Furthermore, the shell can even be made together with the sink or faucet as one piece. The height of the shell varies between 6 and 36 inches depending upon the model chosen (home or industrial), or the look chosen by the customer as shown in FIGS. 2, 3, and 5 (lateral view) & FIGS. 3, 4, 7, and 8 (frontal and perspective view). To manufacture and design the shell, the x and y axis measurements need to be consistent or greater than those of the sink or lavatory FIG. 1 (x & y axis). The shell can be manufactured to fit any type or model of faucet regardless of the size or amount of accessories any particular one utilizes. It is very critical to ensure that the precut openings for the faucets on the sinks and lavatories match the holes on the shells. This is the first point at which they will be attached together. FIGS. 1, 2, 3 (2) Silicon, polyurethane sealant or a precut gasket can be used as the bonding agents for the shell. A few screws could even be added to the ends of the shell for added stability only when a gasket is used as the bonding agent.

(FIGS. 2, 3, 6, and 8 (1)); the shells can also be accessorized. Extra compartments can be built in for added functionality, waterproof electrical outlets (FIGS. 2&8(4)) for those extra cooking appliances needed for special recipes, eliminating the need to unplug other appliances or use extension cords which can be a safety hazard and get in the way. Any wiring required can be hidden within the shell itself for a clean and obstruction free look. The great demand for adaptors of new technologies (i.e., I pod players, cd players, speakers, microphones, remote switches; phone answering systems, front door monitoring systems, even extra lighting) can be built directly into the shell FIGS. 3, 4 &5 (3) and FIGS. 7 & 8 (9). The reasoning behind the extra lighting is to eliminate the need to have all the lights on in the kitchen or restroom if it is not necessary, therefore saving money and energy. The shells can be manufactured with any combination of accessories or none at all. The shells can be modified to accommodate a faucet of any size or shape (FIGS. 4, 8 (5)), adding the option of leaving the knobs and accessories outside the shell, keeping them from water exposure, and eliminating rust, calcium and mildew buildup. This is ideal especially for kitchen islands. It is more convenient to leave more room in between the shell and the lip of the counter against the wall for an easier installation of knobs, and making it easier to clean them. As shown in FIGS. 7 and 8 (10), any type of holder can be built in or attached to the shell for soap, sponges, brushes, utensils, etc. necessary for cleaning. The shell can also be made to allocate the faucet on the inside of the shell only (FIGS. 4, 5, and 6 (8)), and the dishwasher overflow drain (FIGS. 8 (6)). Another form of installing the shell, instead of placing it between the sink and faucet to hold it, a lip can be folded inward or outward around the bottom rim of the shell and bonded to the sink or lavatory adding screws to the ends (FIGS. 2, 3, 6, and 8 (1)).

Lastly, the shell can be manufactured to match the type of countertop it will be attached to or pre built together and attached along with the sink or lavatory as a single piece (FIGS. 3, 5, and 8).

### BRIEF SUMMARY

This new sink and lavatory shell can be manufactured using metal, crystal, glass, synthetic, ceramic or wood materials designed to fit any size or shape of sink or lavatory for home and industrial use. Using these materials it can also be made into any shape desired to change its look to fit into any type of decorative setting. It features three different ways of installation to any sink or lavatory; it can be installed as a single piece around the outside of the faucet, as a single piece attached between the faucet and counter and sink or lavatory to allow some of the faucet accessories to be left on the outside of the shell or simply made together with the counter, sink or lavatory as one piece. The shell can be made with different cuts to accommodate different types and sizes of faucets. The shapes of it can also be changed to achieve a different look. It can be made to be simple with no accessories or accessorized with different compartments for storage, lights, electrical plugs or even adaptors for current technologies such as speakers, remote controls, IPods, etc.

### BRIEF DESCRIPTION OF DRAWINGS

FIG. 1: Shows the most popular types, sizes and shapes of sinks used (rectangular, single, double, triple, oval, irregular, circular and cater cornered sinks). It shows the different cutouts sinks and lavatories (2) come with for their faucets to be attached; these differ with the amounts of accessories a faucet comes with. The x and y axis in this figure represents the working surface in the sink and lavatory.

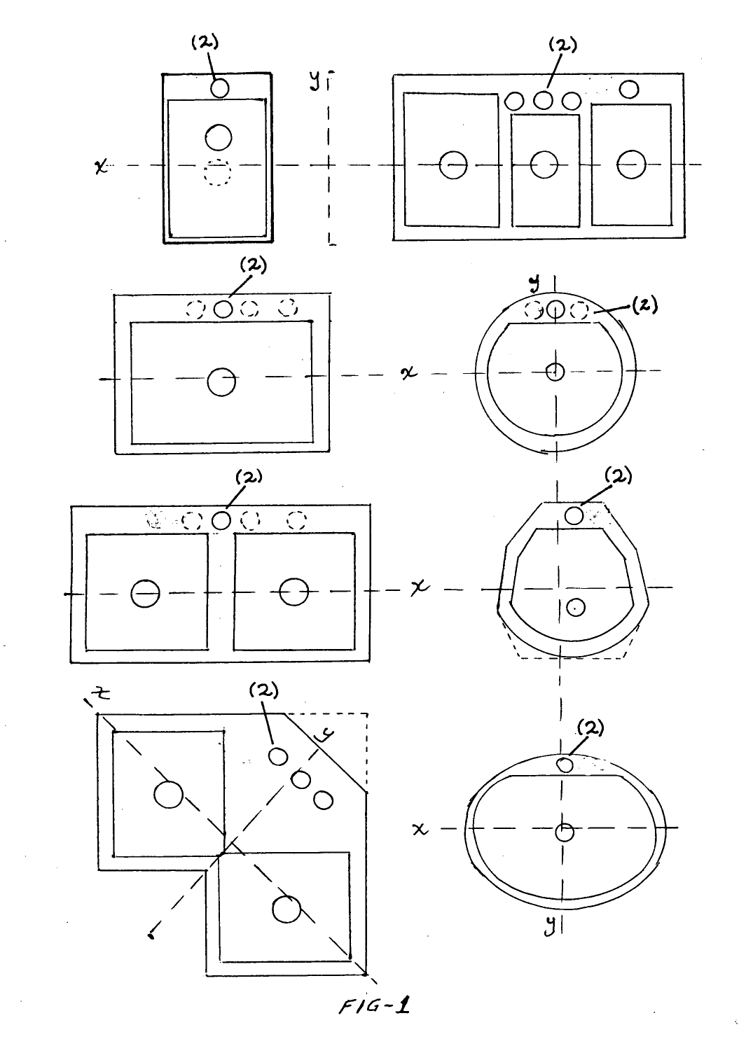

FIG. 2: Shows the lateral and up side view, side by side of four possible designs for the shell represented by the solid lines. It also shows where the electrical plugs (4) could be placed. As well as the different angles the shell can be cut out in. The placement of the screws to mount the shell (1). Also shown are the different placements of cutouts (2) for faucets and knobs.

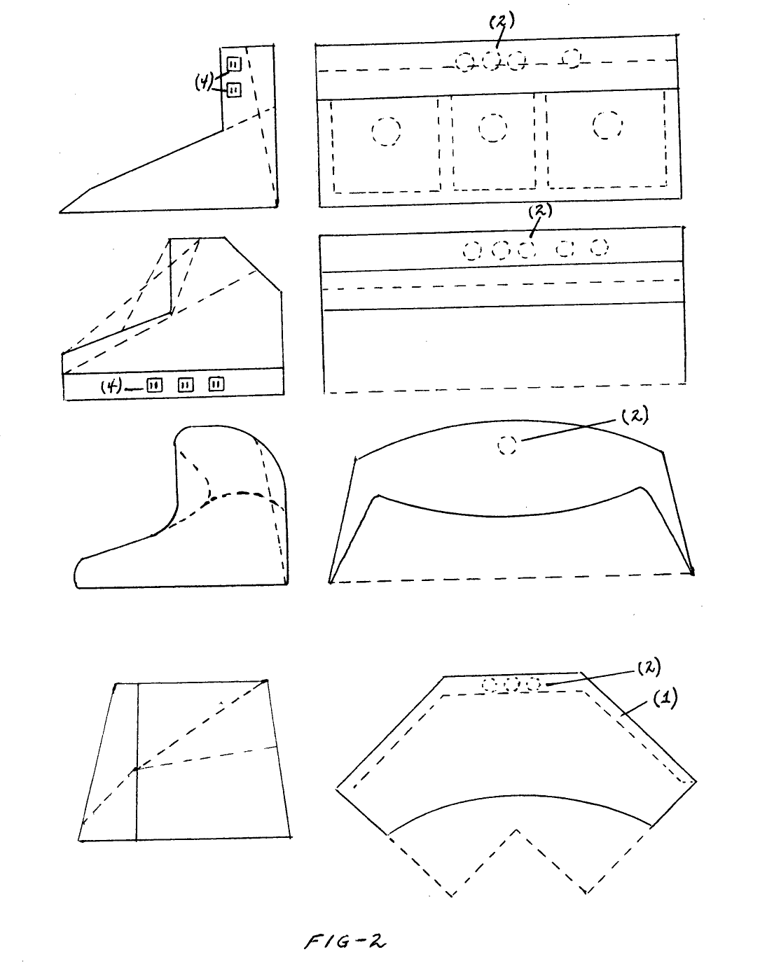

FIG. 3: Shows the perspective views of two sinks. The location of screws if needed (1). A triple sink with the shell showing the whole faucet on the inside (2). The possible location for a light (3).

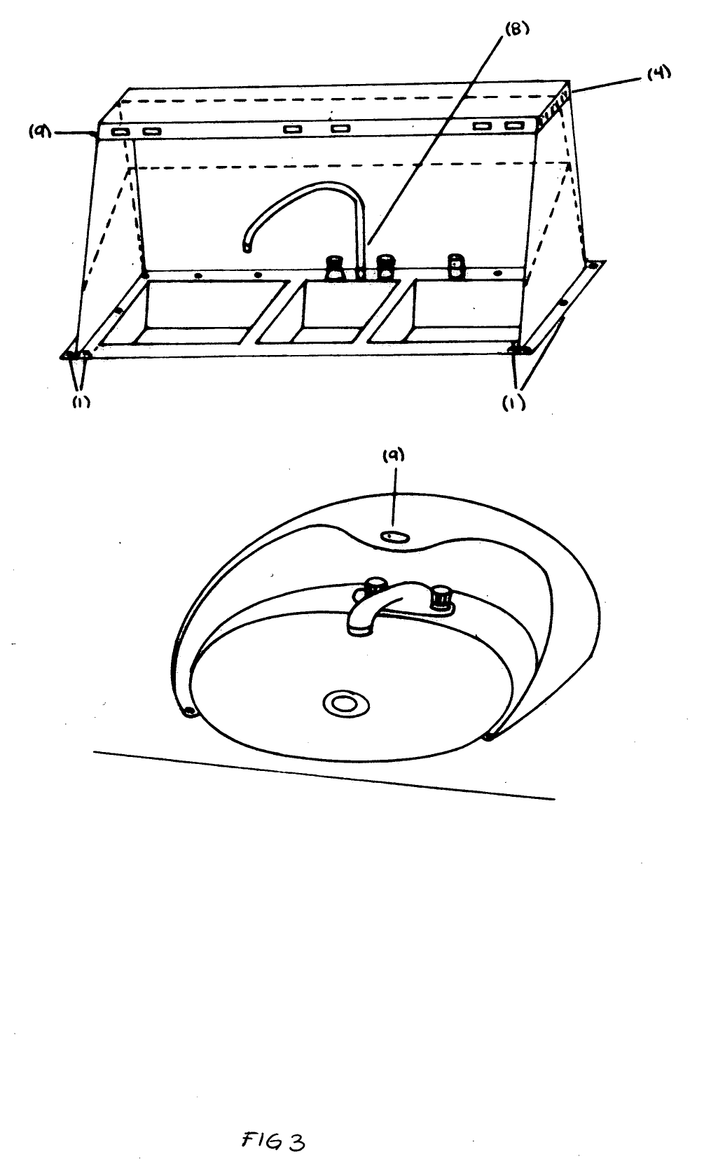

FIG. 4: Shows a frontal view of a shell partially enclosing the faucet (8) through a small cutout (5) and leaving the knobs (8) on the outside shown with dotted lines as well as a possible design of a sea shell for the outer part of it. Also shown is the location for a light (3).

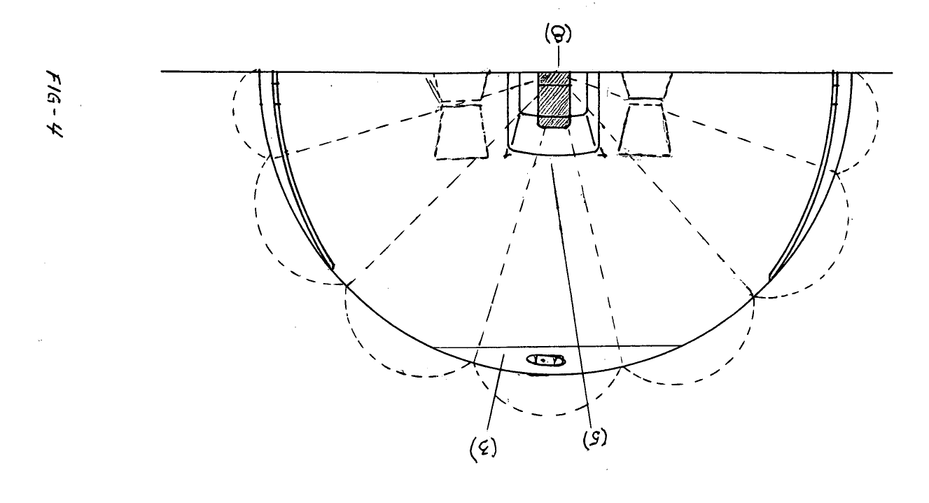

FIG. 5: Shows a lateral view of the shell with various possible cutouts varying in height and depth. This also shows the knobs on the outside and the faucet inside the shell (8). The location of the light (3).

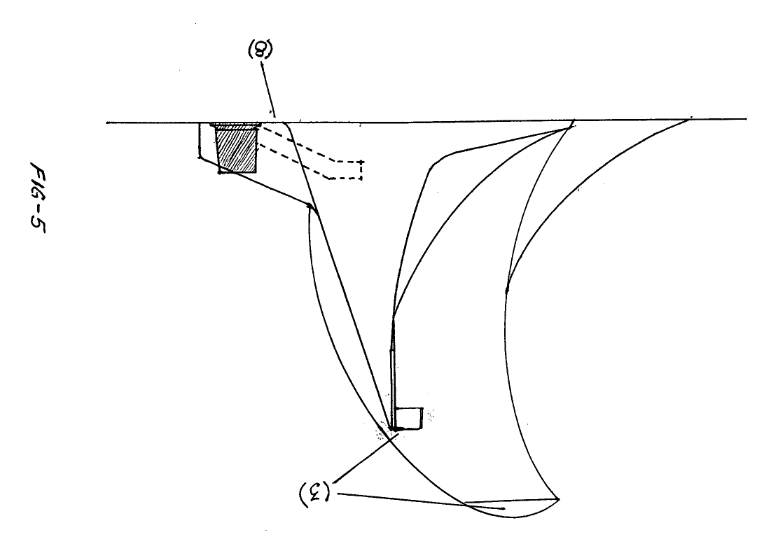

FIG. 6: Shows an up side view of the shell attached to a sink using two screws at both ends (1). This is a simple shell without any extra accessories only leaving the knobs on the outside and the faucet inside (8).

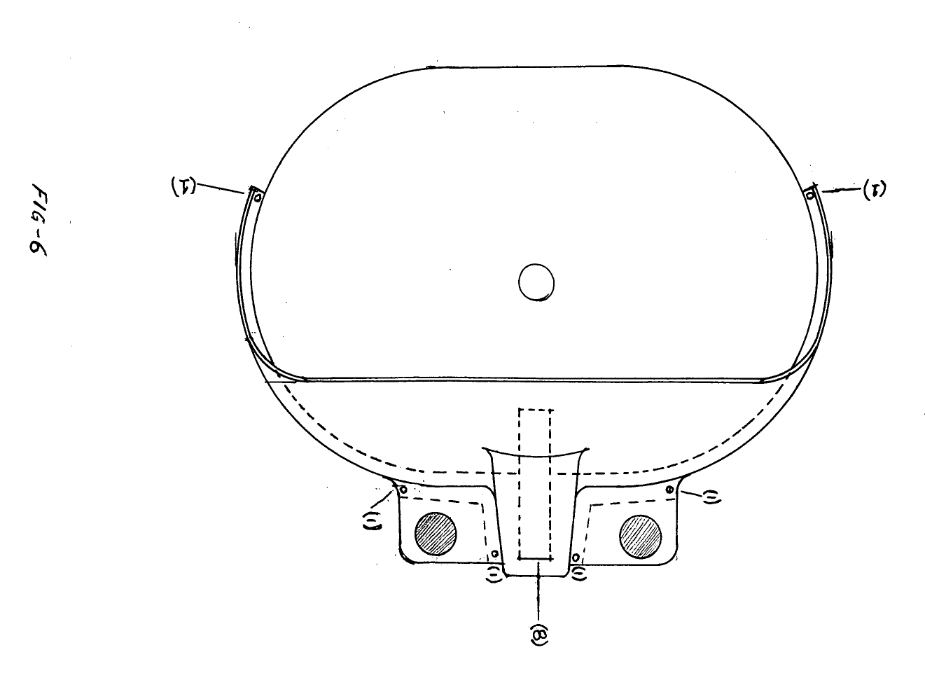

FIG. 7: Shows another possible design of a shell with extra compartments (10) to be used for soap, sponges, etc. Also shows the possible location of a speaker (9).

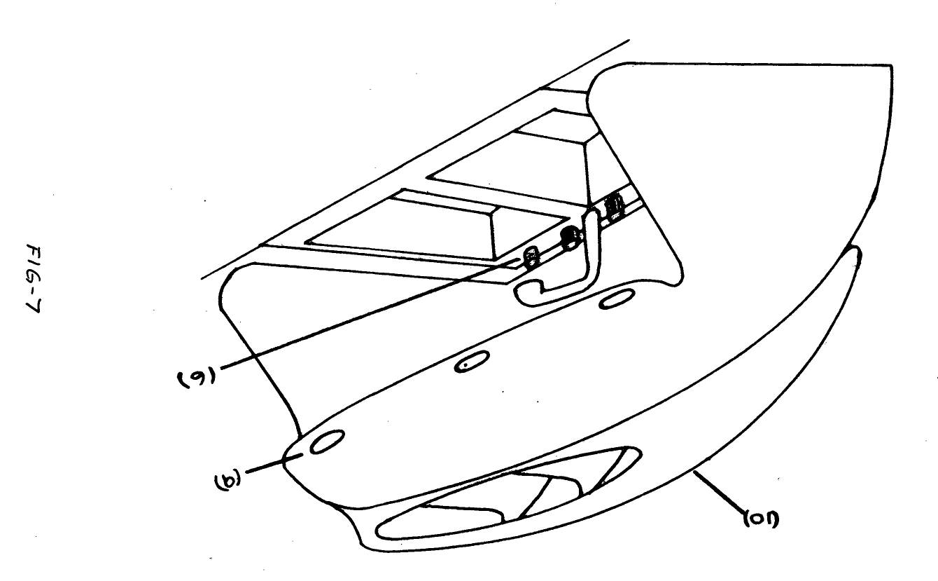

FIG. 8: This shows the possible placement for the screws where the shell will be attached to the sink or countertop (1). Also shows placement for possible electrical outlets (4). Shows the cutout can be used to accommodate any size or model of faucet (5). Also shows the dishwasher overflow drain on the inside of the shell (6), the only accessory that will always be left inside. This shows the possible placement for a speaker (9). This shows the location of storage or utility compartments (10).

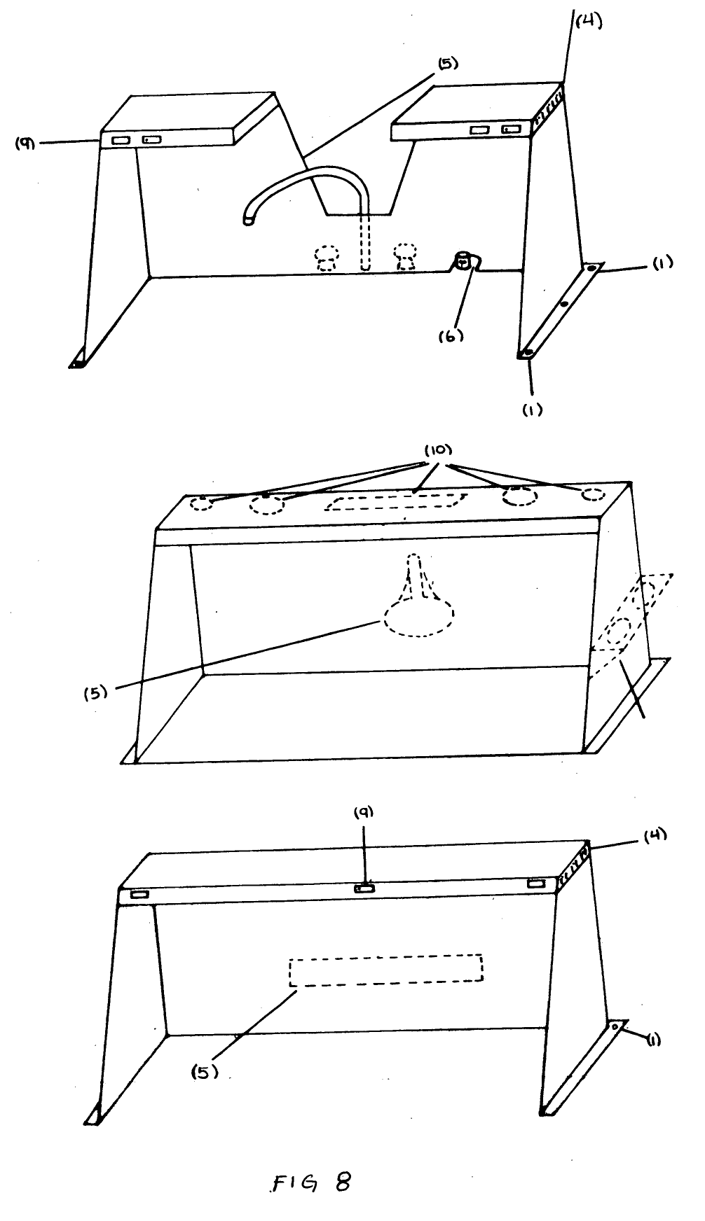

1) Sink and lavatory shell made with metal, crystal, glass, ceramic, plastic, synthetic materials or specially prepared wood.

2) Sink and lavatory shell is made to fit any standard, specially sized or shaped sink or lavatory for use in the home or industrial setting.

3) Sink and lavatory shell is made and designed, using regular or irregular, straight or curved lines, all types of angles, concaved shapes, in order to build, form or mold the shell into the desired look or design and choice of installation.

4) Sink and lavatory shell with different methods of installation, using waterproof methods of bonding and screws whenever necessary. The shell has the capability of being installed in between the faucet and counter or sink, or folding a lip around the bottom rim of the shell to attach it as it is shown and described in the drawings.

5) Sink and lavatory shell with the options of manufacturing it in different designs as shown in the drawings, and with the option of it being cut and modified to fit any type or size of faucet. This includes the option of having all the other sink accessories on the outside of the shell preventing them from constantly being in contact with water.

6) Sink and lavatory shell must always be made to accommodate the dishwasher overflow drain inside, between the shell and sink for the proper utilization.

7) Sink and lavatory shell can be made with extra accessories such as lights and/or extra electrical outlets. The shell can also be manufactured without any of these extra accessories.

8) Sink and lavatory shell can be attached in several ways including welding it, using bonding agents or gaskets, or it can be made already attached to the counter, sink or lavatory to come together as one piece.

9) Sink and lavatory shell that can be plated when metal is used, laminated when wood is used or made with textured materials to change its appearance.

10) Sink and lavatory shell can be accessorized to adapt to current technologies to add speakers, microphones, cd players, remote controls, alerts, IPod attachments, etc.
